(19) United States
(12) Patent Application Publication
(10) Pub. No.: US 2023/0086652 A1
(43) Pub. Date: Mar. 23, 2023

(54) WATER SOLUBLE BUBBLE PACK PAPER MAILER

(71) Applicant: PROAMPAC HOLDINGS INC., Cincinnati, OH (US)

(72) Inventors: Raymond J. Recchia, Cincinnati, OH (US); Seyed Hesamoddin Tabatabaei, Mason, OH (US); Amir Saffar, Laval (CA)

(21) Appl. No.: 17/952,084

(22) Filed: Sep. 23, 2022

Related U.S. Application Data
(60) Provisional application No. 63/247,793, filed on Sep. 23, 2021.

(51) Int. Cl. B65D 81/03; B32B 7/12; B32B 27/10; B32B 27/30; B32B 3/28; B32B 37/12; B65D 65/40

(52) U.S. Cl. CPC B65D 81/03; B32B 7/12; B32B 27/10; B32B 27/306; B32B 3/28; B32B 37/12; B65D 65/40; B32B 2307/7265; B32B 2439/40; B32B 2307/31; B32B 2255/12; B32B 2255/26; B32B 2307/718; B32B 2317/12; B32B 2329/04

(57) ABSTRACT

The present disclosure relates to a recyclable, padded paper mailer that is water resistant, heat sealable, and provides padded protection. The mailers in accordance with this disclosure find utility as padded mailing envelopes such as e-commerce mailers, bubble packaging pillows, or any other protective shipping packaging.

### CROSS REFERENCE TO RELATED APPLICATION

This application claims the priority benefit of U.S. provisional application Ser. No. 63/247,793 filed Sep. 23, 2021. The aforementioned application is incorporated herein by reference in its entirety.

### BACKGROUND

The present disclosure relates to a recyclable, padded paper mailer that is water resistant, heat sealable, and provides padded protection. The mailers in accordance with this disclosure find utility as padded mailing envelopes such as e-commerce mailers, bubble packaging pillows, or any other protective shipping packaging.

Current padded mailers utilize an inner bubble pack layer laminated to an outer paper substrate, wherein the bubble pack film is made out of polyethylene film or a polyethylene/nylon/polyethylene coextruded film. The presence of the polyethylene-based film causes such padded mailers to be non-recyclable in paper recycle streams.

The present disclosure contemplates a new and improved padded paper mailer which overcomes the above-referenced problems and others.

### SUMMARY

The present development provides a padded mailer which uses a bubble pack liner made from a water-soluble polyvinyl alcohol (PVA) film and laminated or glued to a coated paper substrate. The water-soluble PVA film formed into bubble pack is strong enough to maintain levels of padded protection comparable to current paper/bubble pack padded mailers while increasing the sustainability and recyclability of the overall structure.

The present development utilizes a water-soluble polyvinyl alcohol film in a bubble pack format laminated or glued to a coated paper substrate to form a padded paper mailer that provides protection to packaged goods. The coated paper is coated with a water-resistant coating such as polyolefins, acrylics, or coatings that offer water resistance. In embodiments, the water-resistance offered by the coated side of the paper should have a Cobb value (at 120 second contact time under 100 ml of water to wet an area of 100 cm² to a depth of 1 cm) in the range of 20-100 g/m² and, in more preferred embodiments, in the range of 20-80 g/m². In embodiments, the water resistant coating comprises from 1-15 percent by weight, and more preferably 5-15 percent by weight, based on the total paper basis weight. The mailers in accordance with this disclosure removes the need for standard polyethylene (PE) bubble pack that makes current padded paper mailers non-recyclable. The present development is recyclable in paper recycle streams because the water-soluble film dissolves in water.

In one aspect, a padded mailer comprises a front panel having two lateral edges, a top edge, and a bottom edge. A rear panel has two lateral edges, a top edge, and a bottom edge. The front and rear panels are joined along their respective lateral and bottom edges to define an interior. The front and rear panels each comprise an outer ply formed of a water-resistant paper, wherein the outer ply has an inward facing surface and an outward facing surface. An inner ply has an inward facing surface and an outward facing surface, the inner ply formed of an air cellular material, the outward facing surface of the inner ply adhered to the inward facing surface of the outer ply, wherein the air cellular material is formed of a water-soluble polymer.

One advantage of the present development is that it eliminates the need for a polyethylene-based bubble pack as the protective padding in a paper mailer, which would normally render the overall structure non-recyclable in paper recycle streams.

Another advantage of the present development is that it maintains the protective qualities of a standard padded paper mailer.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a plan view of a mailer with an exemplary embodiment of the present invention.

FIG. 2 is a cross-sectional view taken along the lines 2-2 in FIG. 1.

FIG. 3 is a cross-sectional view illustrating the layer structure of an exemplary coated paper/water-soluble polymer bubble pack laminations herein.

FIG. 4 illustrates a laminating section of an exemplary process line for forming the coated paper/water-soluble polymer bubble pack laminations herein.

### DETAILED DESCRIPTION OF THE PREFERRED EMBODIMENTS

Reference will now be made in detail to presently preferred embodiments, one or more examples of which are illustrated in the accompanying drawings. Each example is provided by way of explanation of the invention, not limitation of the invention.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used herein, “recyclable” may refer to a paper-based product that is eligible for acceptance into paper recycling programs, including curbside collection programs and recycling programs that use drop-off locations, including products that comply with one or more promulgated standards or guidelines for recyclability, and including materials that are sufficiently free of plastic materials, such as polyethylene, nylon, polypropylene, polyester, and others which would impede recyclability.

As used herein, “repulpable” may refer to a product that can be reused or remade into paper (e.g., at a paper mill), including products that comply with one or more promulgated standards or guidelines for repulpability, and including materials that are sufficiently free of plastic materials, such as polyethylene, nylon, polypropylene, polyester, and others which would impede repulpability.

All numbers herein are assumed to be modified by the term “about,” unless stated otherwise. The recitation of numerical ranges by endpoints includes all numbers subsumed within that range (e.g., 1 to 5 includes, inter alia, 1, 1.5, 2, 2.75, 3, 3.80, 4, and 5).

Accordingly, unless indicated to the contrary, the numerical parameters set forth in the present specification and attached claims are approximations that can vary depending upon the desired properties sought to be obtained by the presently disclosed subject matter.

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to ±0.01%, from the specified amount, as such variations are appropriate in the disclosed materials and methods.

As used in this application, the terms “front,” “rear,” “top,” “bottom,” “upper,” “left,” “right,” and other orientation descriptors are intended to facilitate the description of the exemplary embodiment(s) of the present invention, and are not intended to limit the structure thereof to any particular position or orientation.

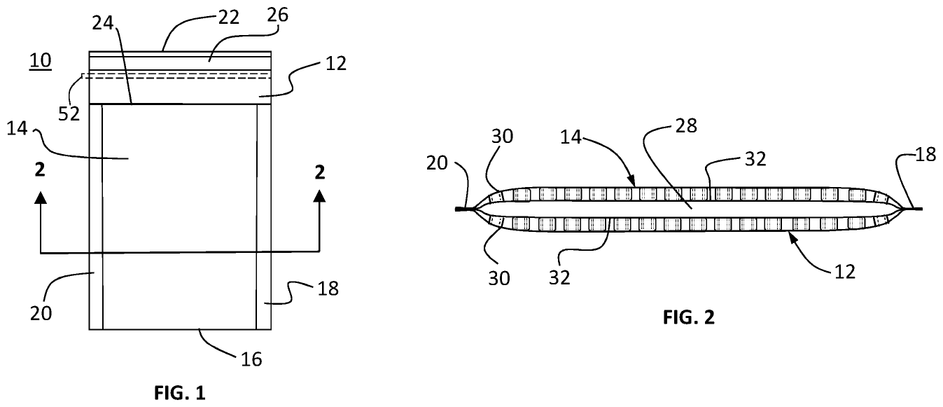

Referring now to the drawings, FIG. 1 shows a mailer 10 formed of a front panel 12 panel and an opposing rear panel 14. The front and rear panels 12, 14 may be formed of a single sheet of material formed of a laminated structure 50 and folded along a bottom edge fold line 16 to form a closed bottom end of the mailer 10. The front and rear panels 12, 14 are sealed along transverse peripheral edges 18, 20 to form closed sides of the mailer 10, thereby defining an interior 28, which is open at the top. A flap 22 is foldable along a fold line 24 to close the top opening once the contents to be shipped have been placed into the interior 28. The flap 22 may include an adhesive strip 26, such as a gum-type adhesive or pressure sensitive adhesive, for securing the flap 22 in a sealed and closed position. In certain embodiments, the adhesive strip 26 is a pressure sensitive adhesive which is covered with a removable liner. The removable liner may be treated with a release agent, such as a silicone release agent. In certain embodiments, the flap 22 may include an easy open feature, such as an optional tear strip 52, as would be understood by persons skilled in the art.

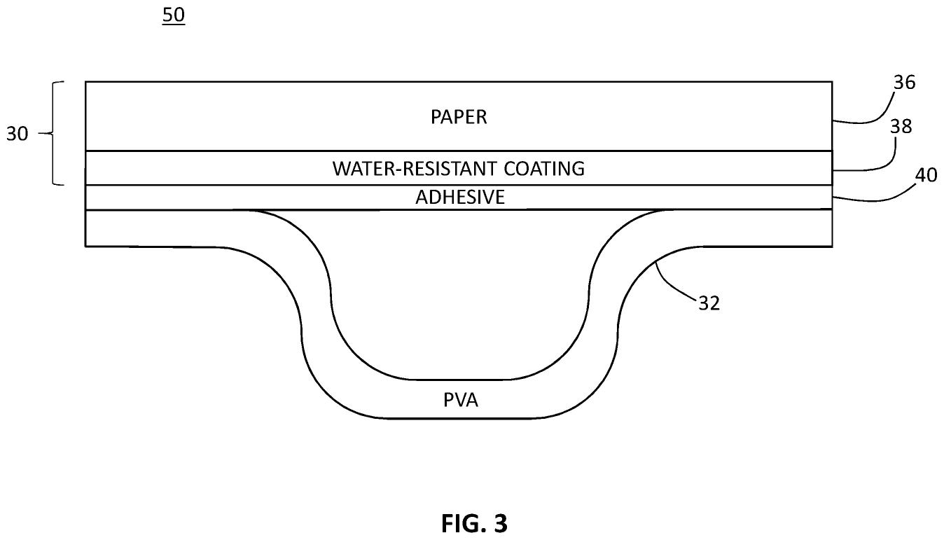

Referring now to FIG. 2, which shows a cross-sectional view of the mailer 10 and FIG. 3, which shows the layer structure of the laminated paper/bubble pack construction 50, each of the front and rear panels 12 and 14, respectively, includes a paper substrate 30, forming the exterior surface of the mailer 10 and a PVA bubble pack layer forming an interior of the mailer 10. The paper substrate 30 includes a paper layer 36 which may be, for example, natural Kraft, bleached Kraft, and the like. In certain embodiments, the paper substrate layer 36 has a basis weight in the range of 40-80#/ream, more preferably 45-70#/ream. In certain embodiments, the paper substrate layer 36 has a basis weight in the range of 68-136 grams per square meter (GSM), more preferably 76-119 GSM.

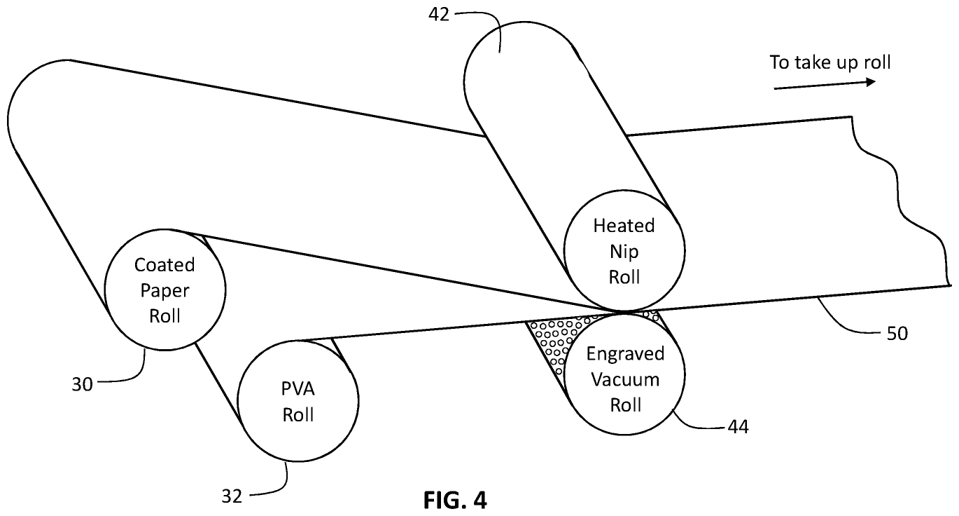

The paper substrate 36 includes a water resistant coating 38, disposed on the inward facing surface of the paper substrate 36. The water resistant coating 38 provides water resistance to the overall structure 10. An air cellular or bubble pack type layer 32 formed of water soluble PVA blown film is laminated or glued to the inward facing, coated surface 38 of the coated paper 30. In certain embodiments, the coated paper 30 and the bubble pack layer 32 are attached using an adhesive layer 40 (see FIG. 3). Exemplary adhesives include water-based & solvent-based adhesives, dry bond. In embodiments, the coated paper 30 and the bubble pack layer 32 are adhesively bonded only at the edges, e.g., in the sealing regions 18 and 20, and are not bonded interiorly thereof. In certain embodiments, the coated paper 30 and the PVA bubble pack layer 32 are laminated by adhesively laminating the PVA 32 to the paper 36. In embodiments, the PVA bubble pack layer 32 maybe be laminated by thermoforming it to the paper 36 using nip rolls and pressure. In embodiments, the paper structure 30 and PVA film 32 are fed through the nip of a heated roller 42 and an engraved vacuum roll 44 as shown in FIG. 4. In embodiments, the PVA film 32 is formed by cast film extrusion, blown film extrusion, or the like. In alternative embodiments, the PVA film layer 32 is brought onto the coated paper 30 via extrusion coating. Because the PVA film 32 is water soluble, the paper substrate 30 is preferably formed of a paper layer 36 having a polymer coating layer 38 to prevent external moisture from coming into contact with the PVA film layer 32.

In embodiments, the paper structure 30 comprises a water-resistant coating 38 such as polyolefins, acrylics, or other coatings exhibiting water resistance, e.g., polyethylene-based film layer, with or without mineral additives or fillers, such as calcium carbonate, talc, silica, clay, and the like.

In certain embodiments, the water-resistant coating layer 38 is formed of a polyolefin-based polymer or copolymer material, preferably a polyethylene-based or polypropylene-based polymer material. In embodiments, the water-resistant coating layer 38 may be comprise a monomaterial or a blend. In certain embodiments, the water-resistant coating layer 38 is formed of polypropylene, high-density polyethylene (HDPE), medium density polyethylene (MDPE), linear medium density polyethylene (LMDPE), low-density polyethylene (LDPE), linear low-density polyethylene (LLDPE), very low-density polyethylene (VLDPE), metallocene linear low-density polyethylene (mLLDPE), polyolefin plastomer (POP), or blends thereof as well as coextrusions thereof.

In certain embodiments, the water-resistant coating layer 38 is formed of a polymer material which comprises a functionalized polyolefin. As used herein, the term functionalized polyolefin means polyolefins synthesized by direct copolymerization with an olefin and a functionalized monomer or by post-polymerization modification of a polyolefin, such as grafting, catalyzed functionalization, or the like. In embodiments, the functionalized polyolefin may be a commercially available functionalized polyolefin tie resin material. In embodiments, the functionalized polyolefin is selected from polyethylene grafted maleic anhydrides (PE-g-MA), polypropylene grafted maleic anhydrides (PP-g-MA), polypropylene grafted acrylic acids (PP-g-AA), ethylene-vinyl acetate (EVA) copolymer resins, ethylene-methacrylic acid (EMAA) copolymer resins, ethylene-methyl acrylate (EMA) copolymer resins, ethylene-methyl methacrylate (EMMA) copolymer resins, ethylene-ethyl acrylate (EEA) copolymer resins, ethylene-butyl acrylate (EBA) copolymer resins, and ethylene n-butyl acrylate (EnBA) copolymer resins, or blends thereof as well as coextrusions thereof.

In the illustrated embodiment, the water-resistant coating layer 38 is depicted as a single layer coating. In alternative embodiments, the water-resistant coating layer 38 may comprise two or more layers, for example, polyethylene, polypropylene, functionalized polyolefin, or any combinations thereof. For example, in embodiments, wherein the water-resistant coating layer 38 comprises multiple layers, a single moisture barrier resin may be used, or alternatively, multiple resins may be used. In embodiments wherein the water-resistant coating layer 38 comprises multiple layers, a coextrusion machine capable of extruding multiple layers may be utilized.

In preferred embodiments, the coating layer 38 is present in an amount which allows the mailer 10 to be recyclable and repulpable after the mailer has been used for its intended purpose that the PVA has been removed by solubilizing the PVA. As used herein, “recyclable” may refer to a product that is eligible for acceptance into recycling programs, including curbside collection programs and recycling programs that use drop-off locations, including products that comply with one or more promulgated standards or guidelines for recyclability, and including materials that are sufficiently free of plastic materials, such as polyethylene, nylon, polypropylene, polyester, and others which would impede recyclability. As used herein, “repulpable” may refer to a product that can be reused or remade into paper (e.g., at a paper mill), including products that comply with one or more promulgated standards or guidelines for repulpability, and including materials that are sufficiently free of plastic materials, such as polyethylene, nylon, polypropylene, polyester, and others which would impede repulpability.

In certain embodiments, the composition of the packaging structures 10 is such that total weight of the polymer materials 38 and 32 and other nonfibrous components minus the weight of the PVA layer 32 does not exceed 20% by weight of the total weight of the packaging structure 10 minus the weight of the PVA layer 32. In certain embodiments, the composition of the packaging structures 10 is such that total weight of the polymer materials 38 and 32 and other nonfibrous components minus the weight of the PVA layer 32 does not exceed 15% by weight of the total weight of the packaging structure minus the weight of the PVA layer 32. In certain embodiments, the composition of the packaging structures 10 is such that total weight of the polymer materials 38 and 32 and other nonfibrous components minus the weight of the PVA layer 32 does not exceed 10% by weight of the total weight of the packaging structure minus the weight of the PVA layer 32. In certain embodiments, the composition of the packaging structures 10 is such that total weight of the polymer materials 38 and 32 and other nonfibrous components minus the weight of the PVA layer 32 does not exceed a maximum amount of plastics or non-paper components in accordance with an established standard or guideline for paper recyclability and/or repulpability.

In embodiments, the paper substrate 30 and the respective bubble pack layer 18 are laminated using an adhesive layer 16, which is preferably a dry lamination adhesive. The front and rear panels are sealed along the edges 18 and 20 by heat sealing the aligned and facing PVA layer 32 in the regions 18 and 20 to form the mailer 10.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof

What is claimed is:

1. A padded mailer, comprising:
a front panel having two lateral edges, a top edge, and a bottom edge; and
a rear panel having two lateral edges, a top edge, and a bottom edge, the front and rear panels joined along their respective lateral and bottom edges to define an interior;
the front and rear panels each comprising:
an outer ply formed of a water-resistant paper, wherein the outer ply has an inward facing surface and an outward facing surface;
an inner ply having an inward facing surface and an outward facing surface, the inner ply formed of an air cellular material, the outward facing surface of the inner ply adhered to the inward facing surface of the outer ply, wherein the air cellular material is formed of a water-soluble polymer.

2. The padded mailer of claim 1, wherein the water-soluble polymer comprises polyvinyl alcohol.

3. The padded mailer of claim 1, wherein the water-soluble polymer is selected from the group consisting of a polyvinyl alcohol blown film, polyvinyl alcohol cast film, and polyvinyl alcohol extrusion coated film.

4. The padded mailer of claim 1, wherein the water-soluble polymer is heat sealable to itself.

5. The padded mailer of claim 1, wherein the water-resistant paper comprises a cellulosic layer and a water-resistant coating layer, the water-resistant coating layer formed of a material selected from the group consisting of polyolefin polymers, polyolefin copolymers, functionalized polyolefins, and acrylic polymers.

6. The padded mailer of claim 5, wherein the water-resistant coating layer is formed of a polyethylene-based film.

7. The padded mailer of claim 5, wherein the water-resistant coating layer comprised a polymer selected from the group consisting of polypropylene, high-density polyethylene (HDPE), medium density polyethylene (MDPE), linear medium density polyethylene (LMDPE), low-density polyethylene (LDPE), linear low-density polyethylene (LLDPE), very low-density polyethylene (VLDPE), metallocene linear low-density polyethylene (mLLDPE), polyolefin plastomer (POP), polyethylene grafted maleic anhydrides (PE-g-MA), polypropylene grafted maleic anhydrides (PP-g-MA), polypropylene grafted acrylic acids (PP-g-AA), ethylene-vinyl acetate (EVA) copolymer resins, ethylene-methacrylic acid (EMAA) copolymer resins, ethylene-methyl acrylate (EMA) copolymer resins, ethylene-methyl methacrylate (EMMA) copolymer resins, ethylene-ethyl acrylate (EEA) copolymer resins, ethylene-butyl acrylate (EBA) copolymer resins, and ethylene n-butyl acrylate (EnBA) copolymer resins, blends of any of the foregoing, and coextrusions of any of the foregoing.

8. The padded mailer of claim 5, wherein the water-resistant coating comprises 1-15 percent by weight based on the total weight of the water-resistant paper.

9. The padded mailer of claim 1, wherein the water-resistant paper has a Cobb value in the range of 20-100 g/m² (at 120 second contact time under 100 ml of water to wet an area of 100 cm² to a depth of 1 cm).

10. The padded mailer of claim 1, wherein the padded mailer is recyclable in a paper recycle stream.

11. The padded mailer of claim 1, further comprising an adhesive layer disposed intermediate the outer ply and the inner ply.

12. The padded mailer of claim 11, wherein the adhesive layer is a dry lamination adhesive.

13. The padded mailer of claim 1, wherein the front and rear panels are separately formed and wherein the bottom edge of the front panel is sealed to the bottom edge of the rear panel.

14. The padded mailer of claim 1, wherein the front and rear panels are integrally formed and wherein the bottom edge of the front panel is adjoined to the bottom edge of the rear panel at a fold line.

15. A method for making a padded mailer, the method comprising.
laminating an first outer ply to a first inner ply to form a front panel, wherein the first outer ply is formed of a water-resistant paper, wherein the first outer ply has an inward facing surface and an outward facing surface, wherein the first inner ply is formed of a water-soluble air cellular material, wherein the first inner ply has an inward facing surface and an outward facing surface, wherein the front panel has two lateral edges, a top edge, and a bottom edge, and wherein the outward facing surface of the first inner ply is adhered to the inward facing surface of the first outer ply;
laminating an second outer ply to a second inner ply to form a front panel, wherein the second outer ply is formed of a water-resistant paper, wherein the second outer ply has an inward facing surface and an outward facing surface, wherein the second inner ply is formed of a water-soluble air cellular material, wherein the second inner ply has an inward facing surface and an outward facing surface, wherein the front panel has two lateral edges, a top edge, and a bottom edge, and wherein the outward facing surface of the second inner ply is adhered to the inward facing surface of the second outer ply; and
joining the front and rear panels along their respective lateral edges to define an interior.

16. The method of claim 14, wherein the water-soluble polymer comprises polyvinyl alcohol.

17. A laminated packaging construction, comprising:
a paper substrate having a first major surface and a second major surface opposite the first major surface;
a water-resistant coating disposed on the first major surface; and
an air cellular material disposed on the water-resistant coating, wherein the air cellular material is formed of a water-soluble polymer.

18. The laminated packaging construction of claim 17, wherein the water-soluble polymer comprises polyvinyl alcohol.
